(19) United States
(12) Patent Application Publication
(10) Pub. No.: US 2026/0145657 A1
(43) Pub. Date: May 28, 2026

(54) BRAKE SYSTEM AND METHOD OF CONTROLLING THE SAME

(71) Applicant: HL MANDO CORPORATION, Peongtaek (KR)

(72) Inventors: Jaehoon JANG, Pyeongtaek (KR); Yongkil KIM, Pyeongteak (KR); Sihun LEE, Pyeongtaek (KR); Gyunghun SIM, Pyeongtaek (KR)

(21) Appl. No.: 19/235,881

(22) Filed: Jun. 12, 2025

(30) Foreign Application Priority Data
Nov. 22, 2024 (KR) 10-2024-0168817

(51) Int. Cl. B60T 13/74

(52) U.S. Cl. CPC B60T 13/741

(57) ABSTRACT

The present disclosure relates to a brake system and a method of controlling the same, the brake system including a plurality of electromechanical brakes including motors respectively installed in wheels of a vehicle and configured to generate braking forces, and a controller configured to receive a signal outputted from a brake pedal sensor of the vehicle, determine target braking torque, and apply motor-applied currents to the motors on the basis of the target braking torque, in which the controller decreases the motor-applied current by a predetermined amount of decrease in electric current when the target braking torque is maintained for a preset period of time, thereby improving energy efficiency by recovering a part of the motor-applied current without affecting actual braking force.

### CROSS-REFERENCE TO RELATED APPLICATIONS

This application claims the priority of Korean Patent Application No. 10-2024-0168817 filed on Nov. 22, 2024, in the Korean Intellectual Property Office, the disclosure of which is incorporated herein by reference.

### BACKGROUND

### Field

The disclosed disclosure relates to a brake system configured to control braking of a vehicle in accordance with hysteresis occurring while an electromechanical brake operates, and a method of controlling the same.

### Description of the Related Art

An electromechanical braking (EMB) system is a technology widely adopted to improve safety and efficiency of a vehicle. This system determines target braking torque in accordance with a driver's braking demand and controls an actuator of an electromechanical brake to achieve the determination of the target braking torque. An actuator controller serves to generate a required clamping force by applying an appropriate electric current to a motor.

In the EMB system in the related art, when the target braking torque is set, a predetermined electric current is continuously supplied to the actuator in order to consistently maintain the clamping force corresponding to the target braking torque. The continuous supply of electric current is important for maintaining the consistency of braking performance but causes several technical problems. In particular, these problems are noticeable in a situation in which the braking force needs to be maintained over a long period of time.

The greatest problem caused by the continuous supply of electric current is excessive heat generation from the actuator. The heat generation not only decreases energy efficiency, but also negatively affects durability of the actuator. An increase in temperature caused by the heat generation may degrade performance of the motor and shorten lifespans of electronic components. As a result, the increase in temperature may lead to deteriorations in reliability and responsiveness of the entire brake system.

### SUMMARY

An object to be achieved by the present disclosure is to provide a brake system capable of recovering a part of a motor-applied current without affecting an actual braking force, and a method of controlling the same.

One aspect of the disclosed disclosure provides a brake system including: a plurality of electromechanical brakes including motors respectively installed in wheels of a vehicle and configured to generate braking forces; and a controller configured to receive a signal outputted from a brake pedal sensor of the vehicle, determine target braking torque, and apply motor-applied currents to the motors on the basis of the target braking torque, in which the controller decreases the motor-applied current by a predetermined amount of decrease in electric current when the target braking torque is maintained for a preset period of time.

The controller may include: a motor controller configured to apply the motor-applied current to the motor on the basis of the target braking torque; and a brake controller configured to transmit the target braking torque to the motor controller.

The brake controller may transmit a hysteresis control signal to the motor controller when the target braking torque is maintained for the preset period of time, and the motor controller may decrease the motor-applied current by the predetermined amount of decrease in electric current when the motor controller receives the hysteresis control signal.

The predetermined amount of decrease in electric current may be determined on the basis of a predefined mapping table.

The predefined mapping table may be configured by a corresponding relationship between the target braking torque, a temperature of the motor, an abrasion degree of a brake pad, and the amount of decrease in electric current for maintaining actual braking torque in accordance with the target braking torque.

The controller may increase the motor-applied current when a change in at least any one of a position of the motor, a position of a brake pad, and actual braking torque is detected after the controller decreases the motor-applied current by the predetermined amount of decrease in electric current.

When a change in the target braking torque is detected after the controller decreases the motor-applied current by the predetermined amount of decrease in electric current, the controller may increase or decrease the motor-applied current on the basis of the changed target braking torque.

When a change in at least any one of a position of the motor, a position of a brake pad, and the actual braking torque is detected while the controller decreases the motor-applied current by the predetermined amount of decrease in electric current, the controller may update the amount of decrease in electric current at a time point before a time point, at which the change is detected, by a predetermined period of time, to the predetermined amount of decrease in electric current in the predefined mapping table.

The controller may increase the predetermined amount of decrease in electric current when a change in at least any one of a position of the motor, a position of a brake pad, the actual braking torque, and the target braking torque is not detected when the motor-applied current is decreased by the predetermined amount of decrease in electric current.

When the change in at least any one of the position of the motor, the position of the brake pad, and the actual braking torque is detected while the motor-applied current is further decreased while corresponding to the increase in the predetermined amount of decrease in electric current, the controller may update the amount of decrease in electric current at a time point before a time point, at which the change is detected, by a predetermined period of time, to the predetermined amount of decrease in electric current in the predefined mapping table.

Another aspect of the disclosed disclosure provides a method of controlling a brake system, the method including: determining target braking torque on the basis of a signal outputted from a brake pedal sensor of a vehicle; applying a motor-applied current to a motor on the basis of the target braking torque; determining whether the target braking torque is maintained for a preset period of time; and decreasing the motor-applied current by a predetermined amount of decrease in electric current when the target braking torque is maintained for the preset period of time.

The predetermined amount of decrease in electric current may be determined on the basis of a predefined mapping table.

The predefined mapping table may be configured by a corresponding relationship between the target braking torque, a temperature of the motor, an abrasion degree of a brake pad, and the amount of decrease in electric current for maintaining actual braking torque in accordance with the target braking torque.

The method of controlling the brake system may further include: increasing the motor-applied current when a change in position of the motor is detected after the motor-applied current is decreased by the predetermined amount of decrease in electric current.

The method of controlling the brake system may further include: increasing the motor-applied current when a change in position of a brake pad is detected after the motor-applied current is decreased by the predetermined amount of decrease in electric current.

The method of controlling the brake system may further include: increasing the motor-applied current when a change in actual braking torque is detected after the motor-applied current is decreased by the predetermined amount of decrease in electric current.

The method of controlling the brake system may further include: increasing or decreasing the motor-applied current on the basis of the changed target braking torque when a change in the target braking torque is detected after the motor-applied current is decreased by the predetermined amount of decrease in electric current.

The method of controlling the brake system may further include: updating the amount of decrease in electric current at a time point before a time point, at which the change is detected, by a predetermined period of time, to the predetermined amount of decrease in electric current in the predefined mapping table when a change in at least any one of a position of the motor, a position of a brake pad, and the actual braking torque is detected while the motor-applied current is decreased by the predetermined amount of decrease in electric current.

The method of controlling the brake system may further include: increasing the predetermined amount of decrease in electric current when a change in at least any one of a position of the motor, a position of a brake pad, the actual braking torque, and the target braking torque is not detected when the motor-applied current is decreased by the predetermined amount of decrease in electric current.

The method of controlling the brake system may further include: updating the amount of decrease in electric current at a time point before a time point, at which a change is detected, by a predetermined period of time, to the predetermined amount of decrease in electric current in the predefined mapping table when the change in at least any one of the position of the motor, the position of the brake pad, and the actual braking torque is detected while the motor-applied current is further decreased while corresponding to the increase in the predetermined amount of decrease in electric current.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating a configuration of a vehicle including a brake system according to an embodiment;

FIG. 2 is a view illustrating a configuration of a controller according to the embodiment;

FIG. 3 is a graph illustrating target braking torque, actual braking torque, and electric currents that change over time during a hysteresis control process according to the embodiment;

FIG. 4 is a view illustrating a hysteresis control operation of the brake system according to the embodiment;

FIG. 5 is a view illustrating an operation of ending hysteresis control during a control operation of the brake system according to the embodiment;

FIG. 6 is a view illustrating an operation of updating a mapping table as a predetermined amount of decrease in electric current increases during the hysteresis control operation of the brake system according to the embodiment; and

FIG. 7 is a view illustrating an operation of updating the mapping table as the predetermined amount of decrease in electric current decreases during the hysteresis control operation of the brake system according to the embodiment.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals indicate like constituent elements throughout the specification. The present specification does not explain all the elements in the embodiments, and the general contents in the technical field to which the disclosed disclosure pertains or the contents repeatedly described in the embodiments will be omitted. The terms ‘part,’ ‘module,’ ‘member,’ ‘block,’ and the like as used in the specification may be implemented in software or hardware. Further, a plurality of ‘part,’ ‘module,’ ‘member,’ ‘block,’ and the like may be embodied as one component. It is also possible that one ‘part,’ ‘module,’ ‘member,’ ‘block,’ and the like includes a plurality of components.

Throughout the present specification, when one constituent element is referred to as being “connected to” another constituent element, one constituent element can be “directly connected to” the other constituent element, and one constituent element can also be “indirectly connected to” the other constituent element. The indirect connection includes a connection through a wireless communication network.

In addition, unless explicitly described to the contrary, the word “comprise/include” and variations such as “comprises/includes” or “comprising/including” will be understood to imply the inclusion of stated elements, not the exclusion of any other elements.

Throughout the specification, when one member is disposed “on” another member, this includes not only a case where the one member is brought into contact with another member, but also a case where still another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, operation principles and embodiments of the disclosed disclosure will be described in detail with reference to the accompanying drawings.

In the present disclosure, the term ‘hysteresis’ refers to a non-linear relationship between a clamping force and a motor-applied current in an electromechanical brake. Specifically, the hysteresis refers to a phenomenon in which the clamping force does not immediately decrease for a predetermined period of time even if the motor-applied current decreases. The hysteresis is caused by mechanical characteristics, frictional characteristics, elastic deformation of materials, and the like of the brake system.

Because of the hysteresis, an actual clamping force is maintained almost in an intact manner even if the motor-applied current is decreased to a predetermined level to maintain a target braking force. In the present disclosure, the characteristics of the hysteresis may be utilized to perform control to decrease the electric current (motor-applied current), which is to be applied to the actuator, to a predetermined degree while maintaining a braking force, and this control is called ‘hysteresis control’.

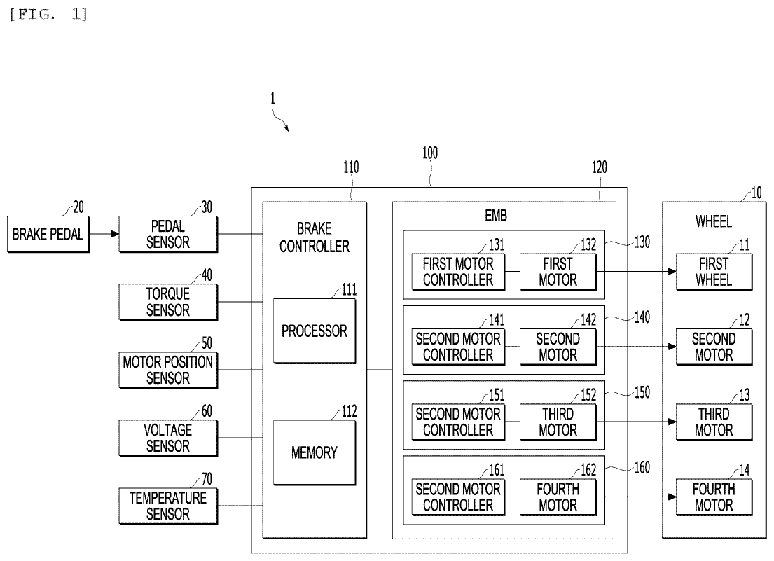

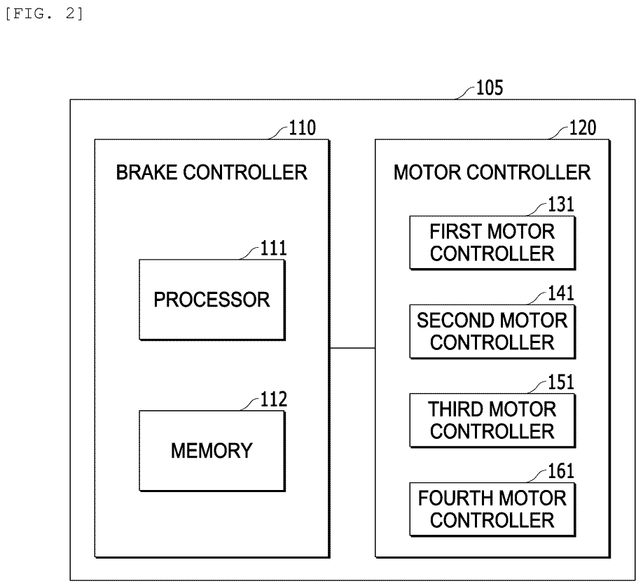

FIG. 1 illustrates a configuration of a vehicle 1 including a brake system 100 according to the embodiment, and FIG. 2 briefly illustrates a configuration of a controller 105 according to the embodiment.

As illustrated in FIG. 1, the vehicle 1 may include wheels 10, a brake pedal 20, a pedal sensor 30, a torque sensor 40, a motor position sensor 50, a voltage sensor 60, a temperature sensor 70, a plurality of electromechanical brakes 120 respectively installed in the wheels 10, and/or a brake controller 110. In addition, the vehicle 1 may further include sensors configured to detect motions (dynamic motions) of the vehicle 1. Although not illustrated, for example, the vehicle 1 may further include wheel speed sensors respectively installed in the wheels 10, a vehicle speed sensor configured to detect a longitudinal velocity of the vehicle 1, an acceleration sensor configured to detect a longitudinal acceleration and a transverse acceleration of the vehicle 1, and/or a gyro sensor configured to detect a yaw angular velocity (yaw rate), a roll angular velocity (roll rate), and a pitch angular velocity (pitch rate) of the vehicle 1.

These components may communicate with one another through a vehicle communication network NT. For example, the electric devices included in the vehicle 1 may send and receive data through Ethernet, media-oriented system transport (MOST), Flexray, controller area network (CAN), and local interconnect network (LIN).

The plurality of electromechanical brakes 120 may be respectively installed in the wheels 10 and serve to stop the vehicle 1. For example, the plurality of electromechanical brakes 120 may include brake calipers, motors 132, 142, 152, and 162 configured to operate the brake calipers, and motor controllers 131, 141, 151, and 161 configured to control the motors. The brake caliper may be operated by an operation of the motor and decelerate or stop the vehicle 1 by using friction with a brake disc.

The plurality of electromechanical brakes 120 may each further include the torque sensor 40, the motor position sensor 50, the voltage sensor 60, and/or the temperature sensor 70 installed in each of the wheels 10.

With reference to FIG. 2, the controller 105 may include the brake controller 110 and a motor controller 120.

The brake controller 110 may transmit target braking torque to the motor controller 120.

The motor controllers 120 may apply motor-applied currents to the motors 132, 142, 152, and 162 on the basis of the target braking torque.

The controller 105 may receive a signal outputted from the brake pedal sensor 30 of the vehicle 1, determine the target braking torque, and apply the motor-applied currents to the motors 132, 142, 152, and 162 on the basis of the target braking torque.

When the target braking torque is maintained for a preset period of time, the controller 105 may decrease the motor-applied current by a predetermined amount of decrease in electric current. The predetermined amount of decrease in electric current may be determined on the basis of a predefined mapping table.

The predefined mapping table may be configured by a corresponding relationship between the target braking torque, temperatures of the motors 132, 142, 152, and 162, an abrasion degree of the brake pad, and the amount of decrease in electric current for maintaining the actual braking torque in accordance with the target braking torque.

After the controller 105 decreases the motor-applied current by the predetermined amount of decrease in electric current, the controller 105 may increase the motor-applied current when a change in at least any one of the positions of the motors 132, 142, 152, and 162, the position of the brake pad, and the actual braking torque is detected.

When a change in target braking torque is detected after the controller 105 decreases the motor-applied current by the predetermined amount of decrease in electric current, the controller 105 may increase or decrease the motor-applied current on the basis of the changed target braking torque.

When a change in at least any one of the positions of the motors 132, 142, 152, and 162, the position of the brake pad, and the actual braking torque is detected while the controller 105 decreases the motor-applied current by the predetermined amount of decrease in electric current, the controller 105 may update the amount of decrease in electric current at a time point before a time point, at which the change is detected, by a predetermined time, to a predetermined amount of decrease in electric current in the predefined mapping table.

The controller 105 may increase the predetermined amount of decrease in electric current when a change in at least any one of the positions of the motors 132, 142, 152, and 162, the position of the brake pad, and the actual braking torque is not detected when the controller 105 decreases the motor-applied current by the predetermined amount of decrease in electric current. That is, the controller 105 may further decrease the motor-applied current. When a change in at least any one of the positions of the motors 132, 142, 152, and 162, the position of the brake pad, and the actual braking torque is detected while the motor-applied current is further decreased while corresponding to the increase in the predetermined amount of decrease in electric current, the controller 105 may update the amount of decrease in electric current at a time point before a time point, at which the change is detected, by a predetermined time, to the predetermined amount of decrease in electric current in the predefined mapping table.

In order for the controller 105 to control the above-mentioned hysteresis control, the brake controller 110 and the motor controller 120 included in the controller 105 are configured to perform cooperative control, and the cooperative control which will be described below.

With reference back to FIG. 1, the motor controllers 131, 141, 151, and 161 may receive and process the signals outputted from the torque sensor 40, the motor position sensor 50, the voltage sensor 60, and/or the temperature sensor 70. Therefore, the motor controllers 131, 141, 151, and 161 may monitor the actual braking torque of the corresponding electromechanical brakes 120, the motor position, the voltages applied to the motors 132, 142, 152, and 162, and the temperatures of the motors 132, 142, 152, and 162.

The motor controllers 131, 141, 151, and 161 may receive the target braking torque from the brake controller 110 and apply the electric currents to the motors 132, 142, 152, and 162 to generate the target braking torque.

The motor controllers 131, 141, 151, and 161 may receive the hysteresis control signal from the brake controller 110, thereby identifying whether the hysteresis control signal is activated. In addition, the motor controllers 131, 141, 151, and 161 may receive a hysteresis control ending signal from the brake controller 110, thereby identifying whether the hysteresis control signal is deactivated.

When the hysteresis control signal is activated, the motor controllers 131, 141, 151, and 161 may decrease the motor-applied current by the predetermined amount of decrease in electric current. That is, when the hysteresis control signal is activated, the motor controllers 131, 141, 151, and 161 may recover the motor-applied current by the predetermined amount of decrease in electric current.

In this case, the motor controllers 131, 141, 151, and 161 may determine the predetermined amount of decrease in electric current on the basis of the predefined mapping table.

In this case, the predefined mapping table may be configured by the corresponding relationship between the target braking torque, the temperatures of the motors 132, 142, 152, and 162, the abrasion degree of the brake pad, and the amount of decrease in electric current for maintaining the actual braking torque in accordance with the target braking torque. For example, the particular target braking torque, the abrasion degree of the brake pad, and the temperatures of the motors 132, 142, 152, and 162 may be given as pairs of parameters, and thus the amount of decrease in electric current for maintaining the actual braking torque in accordance with the target braking torque may be predetermined.

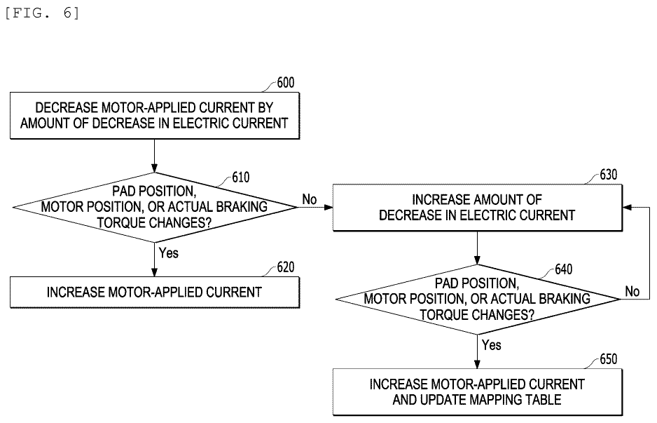

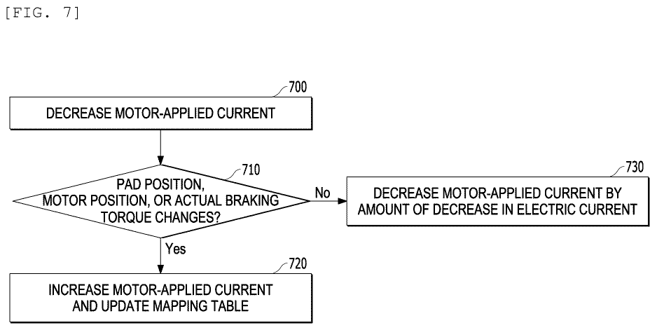

The amount of decrease in electric current may be a predetermined value at the initial time. For example, the initially predetermined amount of decrease in electric current may be a value corresponding to about 7% to 8% of the motor-applied current. Thereafter, the initially predetermined amount of decrease in electric current may be changed to another value or updated. The configuration in which the amount of decrease in electric current is changed or updated will be described below with reference to FIGS. 6 and 7.

The brake controller 110 may be connected, through the vehicle communication network NT, to the pedal sensor 30, the torque sensor 40, the motor position sensor 50, the voltage sensor 60, and the temperature sensor 70 installed in each of the wheels 10, and/or the motor controllers 131, 141, 151, and 161.

The brake controller 110 may receive and process the signal outputted from the pedal sensor 30 and the signals outputted from the torque sensor 40, the motor position sensor 50, the voltage sensor 60, and the temperature sensor 70 installed in each of the wheels 10.

The brake controller 110 may determine the target braking torque required for deceleration on the basis of the signal outputted from the pedal sensor 30 and corresponding to the driver's braking intention and transmit the determined target braking torque to the plurality of electromechanical brakes 120. The brake controller 110 may determine the target braking torque required for deceleration further on the basis of a signal outputted from the wheel speed sensor (not illustrated).

When the target braking torque is maintained for a preset period of time, the brake controller 110 activates the hysteresis control signal. This activation may be implemented as the brake controller 110 transmits the hysteresis control signal to the motor controllers 131, 141, 151, and 161.

The brake controller 110 may deactivate the hysteresis control signal in response to changes in positions of the motors 132, 142, 152, and 162. The brake controller 110 may deactivate the hysteresis control signal in response to a change in position of the brake pad. The brake controller 110 may deactivate the hysteresis control signal in response to a change in position of the actual braking torque. The brake controller 110 may deactivate the hysteresis control signal in response to a change in target braking torque. The deactivation of the hysteresis control signal may be implemented as the brake controller 110 transmits the hysteresis control ending signal to the motor controllers 131, 141, 151, and 161.

The brake controller 110 may include a processor 111 and a memory 112.

The memory 112 may store programs and/or data for processing the signal outputted from the pedal sensor 30, the signals outputted from the torque sensor 40, the motor position sensor 50, the voltage sensor 60, and the temperature sensor 70 installed in each of the wheels 10, and the signal outputted from the wheel speed sensor (not illustrated).

In addition, the memory 112 may store programs and/or data for generating braking torque and/or target braking torque.

In addition, the memory 112 may store the predetermined mapping table of each of the plurality of electromechanical brakes 120 to perform the hysteresis control.

The memory 112 may include not only volatile memories such as an S-RAM or a D-RAM, but also non-volatile memories such as a flash memory, a read-only memory (ROM) or an erasable programmable read-only memory (EPROM).

The processor 111 may process the signal outputted from the pedal sensor 30, the signal outputted from the pedal sensor 30, the signals outputted from the torque sensor 40, the motor position sensor 50, the voltage sensor 60, and the temperature sensor 70 installed in each of the wheels 10, and the signal outputted from the wheel speed sensor (not illustrated).

The processor 111 may generate the target braking torque on the basis of the signal outputted from the pedal sensor 30 (and/or the signal outputted from the wheel speed sensor and transmit the determined target braking torque to the plurality of electromechanical brakes 120.

When the target braking torque is maintained for a preset period of time, the processor 111 may activate the hysteresis control signal. The activation of the hysteresis control signal may be implemented as the processor 111 transmits the hysteresis control signal to the motor controllers 131, 141, 151, and 161.

The processor 111 may deactivate the hysteresis control signal in response to changes in positions of the motors 132, 142, 152, and 162. The processor 111 may deactivate the hysteresis control signal in response to a change in position of the brake pad. The processor 111 may deactivate the hysteresis control signal in response to a change in position of the actual braking torque. The processor 111 may deactivate the hysteresis control signal in response to a change in target braking torque. The deactivation of the hysteresis control signal may be implemented as the processor 111 transmits the hysteresis control ending signal to the motor controllers 131, 141, 151, and 161.

The processor 111 may include a micro control unit (MCU) configured to process the signal outputted from the pedal sensor 30, the signals outputted from the torque sensor 40, the motor position sensor 50, the voltage sensor 60, and the temperature sensor 70 installed in each of the wheels 10, and the signal outputted from the wheel speed sensor (not illustrated) and determine the target braking torque and the actual braking torque.

The brake controller 110 may determine the target braking torque on the basis of the signal outputted from the pedal sensor 30 and transmit the determined target braking torque to electromechanical brakes 130, 140, 150, and 160.

The brake controller 110 may determine whether the target braking torque changes on the basis of the signal outputted from the pedal sensor 30. When the target braking torque is maintained for a predetermined period of time, the brake controller 110 may activate the hysteresis control signal by transmitting the hysteresis control signal to the electromechanical brakes 130, 140, 150, and 160.

In addition, even after the hysteresis control signal is activated, the brake controller 110 may continuously determine whether the target braking torque changes on the basis of the signal outputted from the pedal sensor 30. In case that the target braking torque changes, the brake controller 110 may deactivate the hysteresis control signal by transmitting the hysteresis control ending signal to the electromechanical brakes 130, 140, 150, and 160.

The brake controller 110 determines whether the actual braking torque changes, whether the positions of the motors 132, 142, 152, and 162 change, and whether the position of the brake pad changes on the basis of the signals outputted from the torque sensor 40, the motor position sensor 50, the voltage sensor 60, and the temperature sensor 70 installed in each of the wheels 10. In case that the actual braking torque changes, the positions of the motors 132, 142, 152, and 162 change, or the position of the brake pad changes, the brake controller 110 may deactivate the hysteresis control signal by transmitting the hysteresis control ending signal to the electromechanical brakes 130, 140, 150, and 160.

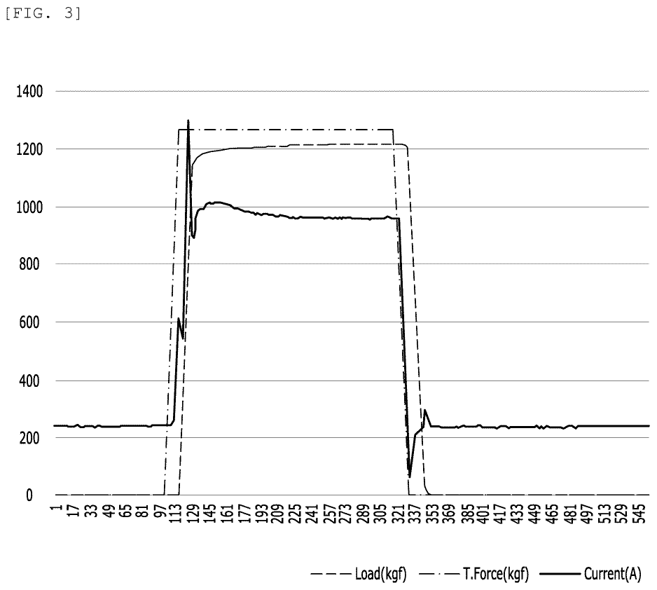

FIG. 3 is a graph illustrating the target braking torque, the actual braking torque, and electric currents that change over time during the hysteresis control process according to the embodiment.

In this case, T.Force (kgf) represents the target braking torque, Load (kgf) represents the actual braking force (or actual braking torque), and Current (A) represents the motor-applied current.

When the target braking torque is determined on the basis of the signal outputted from the pedal sensor 30 in an initial no-load state, the motor controllers 131, 141, 151, and 161 generate motor-applied currents on the basis of the received target braking torque. It is noted that the large fluctuation in the electric current graph at the initial time of braking is due to the occurrence of inrush current. In the electric current graph, the electric current rapidly decreases to 1000 or less on the vertical axis after the occurrence of inrush current and then stays around 1000. For example, when the electric current value in this case is 10.2 A, the motor-applied current corresponding to the target braking torque is 10.2 A.

When the target braking torque graph is maintained for a predetermined period of time, e.g., 2 seconds or more, the condition for performing the hysteresis control is satisfied. Therefore, the motor controllers 131, 141, 151, and 161 may decrease the motor-applied current by the predetermined amount of decrease in electric current on the basis of the hysteresis control signal transmitted by the brake controller 110. For example, the amount of decrease in electric current corresponding to the corresponding target braking torque stored in the predefined mapping table may be 0.7 A. That is, an initial value of the predetermined amount of decrease in electric current corresponding to the corresponding target braking torque is 0.7 A.

With reference to FIG. 3, it can be ascertained that the actual braking force (or actual braking torque) graph does not show a significant change even though the motor-applied current on the electric current graph decreases by 0.7 A as the hysteresis control is performed.

It can be ascertained from the graph in FIG. 3 that the hysteresis control ends as the target braking torque graph changes while the hysteresis control is performed.

That is, as the target braking torque graph shows a rapid decrease, the brake controller 110 transmits the hysteresis control ending signal to the motor controllers 131, 141, 151, and 161. The motor controllers 131, 141, 151, and 161 end the hysteresis control on the basis of the hysteresis control ending signal and perform normal control.

It is noted that FIG. 3 is the graph illustrating a situation in which the hysteresis control ends in accordance with the change in target braking torque while the hysteresis control is performed.

In addition to the situation in FIG. 3, the predetermined mapping table may sometimes be updated. The cases in which the amount of decrease in electric current is changed or updated may be broadly classified into two cases.

First, there is a case in which any one of the abrasion degree of the brake pad and the temperatures of the motors 132, 142, 152, and 162 changes. In this case, the amount of decrease in electric current corresponding to the corresponding target braking torque may be updated to a new amount of decrease in electric current.

For example, as the hysteresis control signal is activated, the actual braking torque may change while the motor controllers 131, 141, 151, and 161 decrease the motor-applied current by the amount of decrease in electric current corresponding to the particular target braking torque. That is, in this case, the positions of the motors 132, 142, 152, and 162 change, the position of the brake pad changes, or the actual braking torque detected by the torque sensor 40 changes. A case in which the actual braking torque changes before the motor controllers 131, 141, 151, and 161 decrease the motor-applied current by the amount of decrease in electric current corresponding to the particular target braking torque refers to a situation in which the hysteresis control cannot be performed. For example, this case also refers to a state in which the actual braking torque cannot follow the corresponding target braking torque any further when the motor-applied current is decreased by the existing amount of decrease in electric current because of a phenomenon such as a significant increase in the abrasion degree of the brake pad.

In other words, this case refers to a situation in which the actual braking force decreases although the actual braking force needs to be maintained without change even though the motor-applied current is decreased by the existing amount of decrease in electric current. Therefore, in this case, the motor controllers 131, 141, 151, and 161 need to update the amount of decrease in electric current to a value smaller than the existing amount of decrease in electric current.

Another case in which the amount of decrease in electric current corresponding to the target braking torque needs to be updated is a case in which the predetermined amount of decrease in electric current is increased when the hysteresis control signal is not deactivated even after the motor controllers 131, 141, 151, and 161 decrease the motor-applied current by the predetermined amount of decrease in electric current as the hysteresis control signal is activated. The state in which the hysteresis control signal is not deactivated refers to a state in which the actual braking force is maintained even though the motor-applied current is decreased by the predetermined amount of decrease in electric current. In this case, the motor controllers 131, 141, 151, and 161 may increase the predetermined amount of decrease in electric current.

For example, the motor controllers 131, 141, 151, and 161 may increase the predetermined amount of decrease in electric current by a predetermined amount in a state in which the hysteresis control signal is not deactivated after the motor-applied current is decreased by the predetermined amount of decrease in electric current. For example, when the predetermined amount of decrease in electric current is 0.7 A, the motor controllers 131, 141, 151, and 161 decreases the existing motor-applied current of 10.2 A to 9.5 A. Thereafter, when the hysteresis control signal is not deactivated, the motor controllers 131, 141, 151, and 161 may decrease the motor-applied current by a predetermined amount, e.g., 0.2 A. Therefore, the motor-applied current, which is 10.2 A before the hysteresis control is performed, decreases to 9.5 A as the predetermined amount of decrease in electric current of 0.7 A is recovered when the hysteresis control is performed, and the motor-applied current further decreases to 9.3 A by 0.2 A when a predetermined period of time elapses in the state in which the hysteresis control signal is not deactivated. In this state, the motor-applied current further decreases to 9.1 A by 0.2 A when a predetermined period of time elapses in the state in which the hysteresis control signal is not deactivated. If the hysteresis control signal is deactivated in this state, the predetermined amount of decrease in electric current changes from 0.7 A to 0.9 A or 1.1 A that is a new amount of decrease in electric current.

The cases in which the hysteresis control signal is deactivated are classified into two cases.

First, there is a case in which the target braking torque changes. For example, there may be a case in which a pedal effort applied to the brake pedal 20 further increases or decreases without being maintained.

Second, there is a case in which the actual braking torque changes even though the target braking torque is maintained. That is, in this case, the positions of the motors 132, 142, 152, and 162 change, the position of the brake pad changes, or the actual braking torque detected by the torque sensor 40 changes.

The amount of decrease in electric current does not need to be changed or updated in a case in which the hysteresis control signal is deactivated by a change in target braking torque.

To this end, the motor controllers 131, 141, 151, and 161 may be configured not to change or update the amount of decrease in electric current in case that the hysteresis control signal is deactivated by the change in target braking torque even though the deactivation of the hysteresis control signal is identified.

To this end, in case that the target braking torque changes, the brake controller 110 may transmit a first hysteresis control ending signal to the motor controllers 131, 141, 151, and 161. In addition, in case that the actual braking torque changes, the brake controller 110 may transmit a second hysteresis control ending signal to the motor controllers 131, 141, 151, and 161.

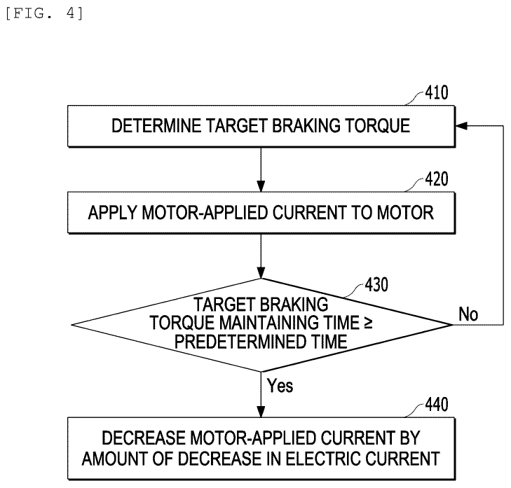

FIG. 4 is a view illustrating a hysteresis control operation of the brake system 100 according to the embodiment.

With reference to FIG. 4, an operation of controlling the brake system 100 may include determining the target braking torque on the basis of the signal outputted from the brake pedal sensor 30 of the vehicle 1 (410), applying the motor-applied current to the motors 132, 142, 152, and 162 on the basis of the target braking torque (420), determining whether the target braking torque is maintained for a preset period of time (430), and decreasing the motor-applied current by the predetermined amount of decrease in electric current when the target braking torque is maintained for a preset period of time (440).

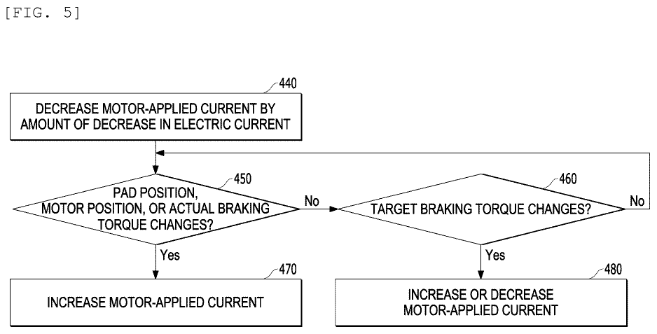

FIG. 5 is a view illustrating an operation of ending hysteresis control during a control operation of the brake system 100 according to the embodiment.

With reference to FIG. 5, an operation of ending the hysteresis control includes decreasing the motor-applied current by the predetermined amount of decrease in electric current when the hysteresis control starts (440), determining whether at least any one of the positions of the motors 132, 142, 152, and 162, the position of the pad, and the actual braking torque changes (450), and increasing the motor-applied current when a change in at least any one of the positions of the motors 132, 142, 152, and 162, the position of the pad, and the actual braking torque is detected (470).

The operation of ending the hysteresis control in FIG. 5 further includes determining whether the target braking torque changes when the change in at least any one of the positions of the motors 132, 142, 152, and 162, the position of the pad, and the actual braking torque is not detected (460), and increasing or decreasing the motor-applied current on the basis of the changed target braking torque when the change in target braking torque is detected (480).

The operation of ending the hysteresis control returns to the determining of whether at least any one of the positions of the motors 132, 142, 152, and 162, the position of the pad, and the actual braking torque changes when the target braking torque does not change (450), and the operation of ending the hysteresis control continuously maintains the hysteresis control.

FIG. 6 is a view illustrating an operation of updating a mapping table as a predetermined amount of decrease in electric current increases during the hysteresis control operation of the brake system 100 according to the embodiment.

With reference to FIG. 6, an operation of updating the mapping table as the predetermined amount of decrease in electric current increases includes decreasing the motor-applied current by the predetermined amount of decrease in electric current (600), determining whether at least any one of the positions of the motors 132, 142, 152, and 162, the position of the pad, and the actual braking torque changes (610), increasing the predetermined amount of decrease in electric current when a change in at least any one of the positions of the motors 132, 142, 152, and 162, the position of the pad, and the actual braking torque is not detected (630), determining again whether at least any one of the positions of the motors 132, 142, 152, and 162, the position of the pad, and the actual braking torque changes (640), and increasing the motor-applied current and updating the mapping table when the change in at least any one of the positions of the motors 132, 142, 152, and 162, the position of the pad, and the actual braking torque is detected (650).

The increasing of the motor-applied current and updating of the mapping table (650) includes updating the amount of decrease in electric current at a time point before a time point, at which the change in at least any one of the positions of the motors 132, 142, 152, and 162, the position of the pad, and the actual braking torque is detected, by a predetermined period of time, to the predetermined amount of decrease in electric current in the predefined mapping table.

The operation of updating the mapping table as the predetermined amount of decrease in electric current increases further includes increasing the motor-applied current when the change in at least any one of the positions of the motors 132, 142, 152, and 162, the position of the pad, and the actual braking torque is detected (620) after the determining of whether at least any one of the positions of the motors 132, 142, 152, and 162, the position of the pad, and the actual braking torque changes (610).

The operation of updating the mapping table as the predetermined amount of decrease in electric current increases returns to the increasing of the predetermined amount of decrease in electric current (630) and continuously maintains the hysteresis control when the change in at least any one of the positions of the motors 132, 142, 152, and 162, the position of the pad, and the actual braking torque is not detected after the determining again of whether at least any one of the positions of the motors 132, 142, 152, and 162, the position of the pad, and the actual braking torque changes (640).

FIG. 6 illustrates the case in which the predetermined amount of decrease in electric current is increased when the hysteresis control signal is not deactivated even after the motor controllers 131, 141, 151, and 161 decrease the motor-applied current by the predetermined amount of decrease in electric current as the hysteresis control signal is activated.

The state in which the hysteresis control signal is not deactivated refers to a state in which the actual braking force is maintained even though the motor-applied current is decreased by the predetermined amount of decrease in electric current. In this case, the motor controllers 131, 141, 151, and 161 may increase the predetermined amount of decrease in electric current.

For example, the motor controllers 131, 141, 151, and 161 may increase the predetermined amount of decrease in electric current by a predetermined amount in a state in which the hysteresis control signal is not deactivated after the motor-applied current is decreased by the predetermined amount of decrease in electric current.

For example, when the predetermined amount of decrease in electric current is 0.7 A, the motor controllers 131, 141, 151, and 161 decreases the existing motor-applied current of 10.2 A to 9.5 A. Thereafter, when the hysteresis control signal is not deactivated, the motor controllers 131, 141, 151, and 161 may decrease the motor-applied current by a predetermined amount, e.g., 0.2 A. Therefore, the motor-applied current, which is 10.2 A before the hysteresis control is performed, decreases to 9.5 A as the predetermined amount of decrease in electric current of 0.7 A is recovered when the hysteresis control is performed, and the motor-applied current further decreases to 9.3 A by 0.2 A when a predetermined period of time elapses in the state in which the hysteresis control signal is not deactivated. In this state, the motor-applied current further decreases to 9.1 A by 0.2 A when a predetermined period of time elapses in the state in which the hysteresis control signal is not deactivated. If the hysteresis control signal is deactivated in this state, the predetermined amount of decrease in electric current changes from 0.7 A to 0.9 A or 1.1 A that is a new amount of decrease in electric current.

FIG. 7 is a view illustrating an operation of updating the mapping table as a predetermined amount of decrease in electric current decreases during the hysteresis control operation of the brake system 100 according to the embodiment.

With reference to FIG. 7, the operation of updating the mapping table as the predetermined amount of decrease in electric current decreases may include decreasing the motor-applied current (700), determining whether at least any one of the positions of the motors 132, 142, 152, and 162, the position of the pad, and the actual braking torque changes (710), and increasing the motor-applied current and updating mapping table when the change in at least any one of the positions of the motors 132, 142, 152, and 162, the position of the pad, and the actual braking torque is detected (730).

The increasing of the motor-applied current and updating of the mapping table (730) includes updating the amount of decrease in electric current at a time point before a time point, at which the change in at least any one of the positions of the motors 132, 142, 152, and 162, the position of the pad, and the actual braking torque is detected, by a predetermined period of time, to the predetermined amount of decrease in electric current in the predefined mapping table.

The operation of updating the mapping table as the predetermined amount of decrease in electric current decreases may further include decreasing the motor-applied current by the amount of decrease in electric current when the change in at least any one of the positions of the motors 132, 142, 152, and 162, the position of the pad, and the actual braking torque is not detected (730) after the determining of whether at least any one of the positions of the motors 132, 142, 152, and 162, the position of the pad, and the actual braking torque changes (710).

FIG. 7 illustrates an operation in a situation in which any one of the abrasion degree of the brake pad and the temperatures of the motors 132, 142, 152, and 162 changes, and the actual braking force changes unexpectedly while the motor-applied current decreases by the existing predetermined amount of decrease in electric current. In this case, the amount of decrease in electric current corresponding to the corresponding target braking torque may be updated to a new amount of decrease in electric current.

For example, as the hysteresis control signal is activated, the actual braking torque may change while the motor controllers 131, 141, 151, and 161 decrease the motor-applied current by the amount of decrease in electric current corresponding to the particular target braking torque. That is, in this case, the positions of the motors 132, 142, 152, and 162 change, the position of the brake pad changes, or the actual braking torque detected by the torque sensor 40 changes. A case in which the actual braking torque changes before the motor controllers 131, 141, 151, and 161 decrease the motor-applied current by the amount of decrease in electric current corresponding to the particular target braking torque refers to a situation in which the hysteresis control cannot be performed. For example, this case also refers to a state in which the actual braking torque cannot follow the corresponding target braking torque any further when the motor-applied current is decreased by the existing amount of decrease in electric current because of a phenomenon such as a significant increase in the abrasion degree of the brake pad.

In other words, this case refers to a situation in which the actual braking force decreases although the actual braking force needs to be maintained without change even though the motor-applied current is decreased by the existing amount of decrease in electric current. Therefore, in this case, the motor controllers 131, 141, 151, and 161 need to update the amount of decrease in electric current to a value smaller than the existing amount of decrease in electric current.

It should be noted in FIGS. 6 and 7 that the cases in which the hysteresis control signal is deactivated are classified into two cases. First, there is a case in which the target braking torque changes. For example, there may be a case in which a pedal effort applied to the brake pedal 20 further increases or decreases without being maintained. Second, there is a case in which the actual braking torque changes even though the target braking torque is maintained. That is, in this case, the positions of the motors 132, 142, 152, and 162 change, the position of the brake pad changes, or the actual braking torque detected by the torque sensor 40 changes.

In this case, the amount of decrease in electric current does not need to be changed or updated in a case in which the hysteresis control signal is deactivated by a change in target braking torque.

To this end, the motor controllers 131, 141, 151, and 161 may be configured not to change or update the amount of decrease in electric current in case that the hysteresis control signal is deactivated by the change in target braking torque even though the deactivation of the hysteresis control signal is identified.

To this end, in case that the target braking torque changes, the brake controller 110 may transmit a first hysteresis control ending signal to the motor controllers 131, 141, 151, and 161. In addition, in case that the actual braking torque changes, the brake controller 110 may transmit a second hysteresis control ending signal to the motor controllers 131, 141, 151, and 161.

As described above, the brake system 100 according to the embodiment of the present disclosure performs the hysteresis control for decreasing the motor-applied current in accordance with the hysteresis in comparison with the related art, thereby reducing the consumption current and improving the energy efficiency. In addition, therefore, it is possible to improve the durability and life expectancy of the components by reducing heat generation from the actuator.

The above description is simply given to illustratively describe the technical spirit of the present disclosure, and those skilled in the art to which the present disclosure pertains will appreciate that various changes and modifications are possible without departing from the essential characteristic of the present disclosure. Therefore, the embodiments disclosed in the present disclosure are provided for illustrative purposes only but are not intended to limit the technical spirit of the present disclosure. The scope of the technical spirit of the present disclosure is not limited thereby. The protective scope of the present disclosure should be construed based on the following claims, and all the technical spirit in the equivalent scope thereto should be construed as falling within the scope of the present disclosure.

What is claimed is:

1. A brake system comprising:
a plurality of electromechanical brakes comprising motors respectively installed in wheels of a vehicle and configured to generate braking forces; and
a controller configured to receive a signal outputted from a brake pedal sensor of the vehicle, determine target braking torque, and apply motor-applied currents to the motors on the basis of the target braking torque,
wherein the controller decreases the motor-applied current by a predetermined amount of decrease in electric current when the target braking torque is maintained for a preset period of time.

2. The brake system of claim 1, wherein the controller comprises:
a motor controller configured to apply the motor-applied current to the motor on the basis of the target braking torque; and
a brake controller configured to transmit the target braking torque to the motor controller.

3. The brake system of claim 2, wherein the brake controller transmits a hysteresis control signal to the motor controller when the target braking torque is maintained for the preset period of time, and the motor controller decreases the motor-applied current by the predetermined amount of decrease in electric current when the motor controller receives the hysteresis control signal.

4. The brake system of claim 1, wherein the predetermined amount of decrease in electric current is determined on the basis of a predefined mapping table.

5. The brake system of claim 4, wherein the predefined mapping table is configured by a corresponding relationship between the target braking torque, a temperature of the motor, an abrasion degree of a brake pad, and the amount of decrease in electric current for maintaining actual braking torque in accordance with the target braking torque.

6. The brake system of claim 1, wherein the controller increases the motor-applied current when a change in at least any one of a position of the motor, a position of a brake pad, and actual braking torque is detected after the controller decreases the motor-applied current by the predetermined amount of decrease in electric current.

7. The brake system of claim 1, wherein when a change in the target braking torque is detected after the controller decreases the motor-applied current by the predetermined amount of decrease in electric current, the controller increases or decreases the motor-applied current on the basis of the changed target braking torque.

8. The brake system of claim 4, wherein when a change in at least any one of a position of the motor, a position of a brake pad, and the actual braking torque is detected while the controller decreases the motor-applied current by the predetermined amount of decrease in electric current, the controller updates the amount of decrease in electric current at a time point before a time point, at which the change is detected, by a predetermined period of time, to the predetermined amount of decrease in electric current in the predefined mapping table.

9. The brake system of claim 4, wherein the controller increases the predetermined amount of decrease in electric current when a change in at least any one of a position of the motor, a position of a brake pad, the actual braking torque, and the target braking torque is not detected when the motor-applied current is decreased by the predetermined amount of decrease in electric current.

10. The brake system of claim 9, wherein when the change in at least any one of the position of the motor, the position of the brake pad, and the actual braking torque is detected while the motor-applied current is further decreased while corresponding to the increase in the predetermined amount of decrease in electric current, the controller updates the amount of decrease in electric current at a time point before a time point, at which the change is detected, by a predetermined period of time, to the predetermined amount of decrease in electric current in the predefined mapping table.

11. A method of controlling a brake system, the method comprising:
determining target braking torque on the basis of a signal outputted from a brake pedal sensor of a vehicle;
applying a motor-applied current to a motor on the basis of the target braking torque;
determining whether the target braking torque is maintained for a preset period of time; and
decreasing the motor-applied current by a predetermined amount of decrease in electric current when the target braking torque is maintained for the preset period of time.

12. The method of claim 11, wherein the predetermined amount of decrease in electric current is determined on the basis of a predefined mapping table.

13. The method of claim 12, wherein the predefined mapping table is configured by a corresponding relationship between the target braking torque, a temperature of the motor, an abrasion degree of a brake pad, and the amount of decrease in electric current for maintaining actual braking torque in accordance with the target braking torque.

14. The method of claim 11, further comprising:
increasing the motor-applied current when a change in position of the motor is detected after the motor-applied current is decreased by the predetermined amount of decrease in electric current.

15. The method of claim 11, further comprising:
increasing the motor-applied current when a change in position of a brake pad is detected after the motor-applied current is decreased by the predetermined amount of decrease in electric current.

16. The method of claim 11, further comprising:
increasing the motor-applied current when a change in actual braking torque is detected after the motor-applied current is decreased by the predetermined amount of decrease in electric current.

17. The method of claim 11, further comprising:
increasing or decreasing the motor-applied current on the basis of the changed target braking torque when a change in the target braking torque is detected after the motor-applied current is decreased by the predetermined amount of decrease in electric current.

18. The method of claim 12, further comprising:
updating the amount of decrease in electric current at a time point before a time point, at which the change is detected, by a predetermined period of time, to the predetermined amount of decrease in electric current in the predefined mapping table when a change in at least any one of a position of the motor, a position of a brake pad, and the actual braking torque is detected while the motor-applied current is decreased by the predetermined amount of decrease in electric current.

19. The method of claim 12, further comprising:
increasing the predetermined amount of decrease in electric current when a change in at least any one of a position of the motor, a position of a brake pad, the actual braking torque, and the target braking torque is not detected when the motor-applied current is decreased by the predetermined amount of decrease in electric current.

20. The method of claim 19, further comprising:
updating the amount of decrease in electric current at a time point before a time point, at which a change is detected, by a predetermined period of time, to the predetermined amount of decrease in electric current in the predefined mapping table when the change in at least any one of the position of the motor, the position of the brake pad, and the actual braking torque is detected while the motor-applied current is further decreased while corresponding to the increase in the predetermined amount of decrease in electric current.
